(19) United States
(12) Patent Application Publication
(10) Pub. No.: US 2026/0176182 A1
(43) Pub. Date: Jun. 25, 2026

(54) MINERALIZATION WATERWAY SYSTEM AND MINERALIZATION WATER PURIFIER

(71) Applicant: Guangdong Lizi Technology Co., Ltd., Foshan (CN)

(72) Inventors: Xing Zhan, Foshan (CN); Wenbin Chen, Foshan (CN); Jiawei Chen, Foshan (CN); Yutai Huang, Foshan (CN); Guoxiang Chen, Foshan (CN); Yijie Hao, Foshan (CN); Jianbo Huang, Foshan (CN); Wei Luo, Foshan (CN)

(21) Appl. No.: 19/023,465

(22) Filed: Jan. 16, 2025

(30) Foreign Application Priority Data
Dec. 19, 2024 (CN) 202411884123.6

(51) Int. Cl. C02F 9/00; B01D 15/08; B01D 61/02; B01D 61/08; B01D 61/12; C02F 1/28; C02F 1/44; C02F 1/68

(52) U.S. Cl. CPC C02F 9/00; B01D 15/08; B01D 61/026; B01D 61/08; B01D 61/12; B01D 2311/06; B01D 2313/18; B01D 2317/02; B01D 2317/04; C02F 1/281; C02F 1/441; C02F 1/688; C02F 2201/005; C02F 2209/06; C02F 2209/40; C02F 2301/08; C02F 2307/14

(57) ABSTRACT

A mineralization waterway system and a mineralization water purifier are provided. A first valve body is connected to a first and a second filter element unit, so that water in a water inlet pipeline can enter different filter elements. The first filter element unit is further connected to the second filter element unit. Under the circumstance, the water in the water inlet pipeline can enter the second filter element unit through the first filter element unit and is filtered by the second filter element unit. A plurality of water filtering channels provided in the embodiments solve a problem that a flow rate of an existing mineralization waterway system cannot be adjusted. In addition, the first filter element unit and the second filter element unit are further connected to a mineralization filter element unit, and water mineralized by the mineralization filter element unit is discharged through a water outlet pipeline.

### CROSS REFERENCE TO RELATED APPLICATIONS

The present application claims the benefit of Chinese Patent Application No. 202411884123.6 filed on Dec. 19, 2024, the contents of which are incorporated herein by reference in their entirety.

### TECHNICAL FIELD

The present disclosure relates to the technical field of water purification, and in particular, to a mineralization waterway system and a mineralization water purifier.

### BACKGROUND

A water purifier is equipment for improving water quality, removing impurities from water, or adjusting the water quality. A water purifier with a mineral water mineralization function is a kind of water purification equipment that can deeply purify tap water and add mineral elements required by a human body to make the water quality meet a standard similar to mineral water. After harmful substances are removed, the water purifier with the mineral water mineralization function integrates minerals such as calcium, magnesium, iron, and zinc which are required by the human body into water by adding a mineral-rich filter material. These minerals exist in ionic states and are more easily absorbed by the human body. However, meeting different needs of a user for water outlet volumes in different scenarios has become a problem that needs to be urgently solved for the current water purifier.

### SUMMARY

In view of this, embodiments of the present disclosure provide a mineralization waterway system which can meet different needs of a user for water outlet volumes in different scenarios.

A first aspect of the present disclosure provides a mineralization waterway system, including:
a water inlet pipeline;
a water outlet pipeline;
a first filter element unit and a second filter element unit;
a mineralization filter element unit, connected to the water outlet pipeline; and
a first valve body, including a first water outlet end and a second water outlet end, wherein the first water outlet end is connected to the first filter element unit, and the second water outlet end is connected to the second filter element unit;
wherein when the mineralization waterway system is in a first gear, water flows from the water inlet pipeline into the first valve body, and then flows out from the first water outlet end to the first filter element unit; purified water obtained by the first filter element unit enters the mineralization filter element unit; wastewater discharged from the first filter element unit enters the second filter element unit; purified water obtained by the second filter element unit enters the mineralization filter element unit; and water mineralized by the mineralization filter element unit is discharged through the water outlet pipeline.

Optionally, a wastewater pipeline is arranged between a wastewater outlet of the first filter element unit and a water inlet end of the second filter element unit; a check valve is arranged on the wastewater pipeline; and the check valve is configured to allow the wastewater filtered from the first filter element unit to flow into the second filter element unit and prohibit back flowing.

Optionally, when the mineralization waterway system is in a second gear, water flows from the water inlet pipeline into the first valve body, and then flows out from the first water outlet end to the first filter element unit; purified water obtained by the first filter element unit enters the mineralization filter element unit; and wastewater discharged from the first filter element unit is discharged through a first wastewater discharging channel.

Optionally, when the mineralization waterway system is in the second gear, when the mineralization waterway system is a third gear, water flows from the water inlet pipeline into the first valve body, and then flows out from the second water outlet end to the second filter element unit; purified water obtained by the second filter element unit enters the mineralization filter element unit; and wastewater discharged from the second filter element unit is discharged through a second wastewater discharging channel.

Optionally, when the mineralization waterway system is in the second gear, when the mineralization waterway system is in a fourth gear, water flows from the water inlet pipeline into the first valve body, then flows out from the first water outlet end to the first filter element unit, and flows out from the second water outlet end to the second filter element unit; purified water obtained by the first filter element unit and purified water obtained by the second filter element unit enter the mineralization filter element unit; wastewater discharged from the first filter element unit is discharged through the first wastewater discharging channel; and wastewater discharged from the second filter element unit is discharged through the second wastewater discharging channel.

Optionally, the first filter element unit is provided with a plurality of first filter sub-elements; and the plurality of first filter sub-elements are connected in series or in parallel in sequence or are in parallel-series connection in sequence.

Optionally, the second filter element unit is provided with a plurality of second filter sub-elements; and the plurality of second filter sub-elements are connected in series or in parallel in sequence or are in parallel-series connection in sequence.

Optionally, the mineralization filter element unit includes a mineralization pipeline, and a mineralization filter element is arranged on the mineralization pipeline.

Optionally, the mineralization filter element unit includes: a mineralization pipeline and an inhibition pipeline which are arranged in parallel and capable of simultaneously or separately discharging water; the mineralization pipeline is provided with a mineralization filter element; the inhibition pipeline is provided with an inhibition filter element; a serially-connected switching pipeline is arranged between the mineralization pipeline and the inhibition pipeline; the serially-connected switching pipeline is configured to connect the inhibition filter element to the mineralization filter element in series; an output side of the serially-connected switching pipeline is connected to the mineralization pipeline or the mineralization filter element; an input side of the serially-connected switching pipeline is connected to the inhibition pipeline or the inhibition filter element; and a control valve is arranged on the serially-connected switching pipeline.

Optionally, the mineralization filter element includes a zinc-containing filter material; and the inhibition filter element includes an alkaline filter material.

Optionally, the mineralization filter element includes a first alkaline filter material; the inhibition filter element includes a second alkaline filter material; and the second alkaline filter material is configured to inhibit dissolution of an alkaline substance from the first alkaline filter material.

Optionally, the mineralization filter element unit includes: a mineralization pipeline and an acceleration pipeline which are arranged in parallel and capable of simultaneously or separately discharging water; the mineralization pipeline is provided with a mineralization filter element; the acceleration pipeline is provided with an acceleration filter element; a serially-connected switching pipeline is arranged between the mineralization pipeline and the acceleration pipeline; the serially-connected switching pipeline is configured to connect the acceleration filter element to the mineralization filter element in series; an output side of the serially-connected switching pipeline is connected to the mineralization pipeline or the mineralization filter element; an input side of the serially-connected switching pipeline is connected to the acceleration pipeline or the acceleration filter element; and a control valve is arranged on the serially-connected switching pipeline.

Optionally, the mineralization filter element includes a metasilicic-acid-containing filter material, and the acceleration filter element includes an alkaline filter material.

Optionally, the mineralization filter element includes maifanite, and the acceleration filter element includes periclase.

Optionally, the mineralization filter element unit includes: a mineralization pipeline, an inhibition pipeline, and an acceleration pipeline which are arranged in parallel and capable of simultaneously or separately discharging water; the mineralization pipeline is provided with a mineralization filter element; the inhibition pipeline is provided with an inhibition filter element; the acceleration pipeline is provided with an acceleration filter element; a first connection pipeline is arranged between the mineralization pipeline and the inhibition pipeline; an output side of the first connection pipeline is connected to the mineralization pipeline or the mineralization filter element; an input side of the first connection pipeline is connected to the inhibition pipeline or the inhibition filter element; a first control valve is arranged at the first connection pipeline; a second connection pipeline is arranged between the mineralization pipeline and the acceleration pipeline; an output side of the second connection pipeline is connected to the mineralization pipeline or the mineralization filter element; an input side of the second connection pipeline is connected to the acceleration pipeline or the acceleration filter element; the first control valve is arranged at the first connection pipeline; and a second control valve is arranged at the second connection pipeline.

Optionally, the mineralization filter element includes a metasilicic-acid-containing filter material; the acceleration filter element includes an alkaline filter material; and the inhibition filter element includes a zeolite filter material.

Optionally, the mineralization waterway system further includes: a first water quality testing instrument and a second water quality testing instrument, wherein the first water quality testing instrument is configured to test a first water quality parameter of an upstream of the mineralization filter element unit; the second water quality testing instrument is configured to test a second water quality parameter of a downstream of the mineralization filter element unit; and a difference between the first water quality parameter and the second water quality parameter is configured to determine a pH value of the water flowing out of the mineralization filter element unit.

Optionally, a variable frequency water pump is arranged at the water inlet pipeline.

Optionally, a pump rate of the variable frequency water pump is different according to different gears of the mineralization waterway system and different parameter differences between the first water quality parameter and the second water quality parameter, to control the pH of the water obtained according to the parameter difference within a preset pH range.

A second aspect of the present disclosure provides a mineralization water purifier including the mineralization waterway system.

According to the mineralization waterway system and the mineralization water purifier provided in the embodiments of the present disclosure, the first valve body is connected to the first filter element unit and the second filter element unit respectively, so that water in the water inlet pipeline can enter different filter elements. Meanwhile, the first filter element unit is further connected to the second filter element unit. Under the circumstance, the water in the water inlet pipeline can enter the second filter element unit through the first filter element unit and is filtered by the second filter element unit. A plurality of water filtering channels provided in the embodiments solve a problem that a flow rate of the existing mineralization waterway system cannot be adjusted.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some of the embodiments of the present disclosure, and a person of ordinary skill in the art may still derive other drawings from the accompanying drawings without creative efforts.

FIG. 1 is a schematic structural diagram of a mineralization waterway system according to an embodiment of the present disclosure.

FIG. 2 is a schematic structural diagram of another mineralization waterway system according to an embodiment of the present disclosure.

FIG. 3 is a schematic structural diagram of a plurality of filter sub-elements connected in series in sequence according to an embodiment of the present disclosure.

FIG. 4 is a schematic structural diagram of a plurality of filter sub-elements connected in parallel according to an embodiment of the present disclosure.

FIG. 5 is a schematic structural diagram of a plurality of filter sub-elements which are in parallel-series connection according to an embodiment of the present disclosure.

FIG. 6 is a schematic structural diagram of a plurality of second sub-elements connected in series in sequence according to an embodiment of the present disclosure.

FIG. 7 is a schematic structural diagram of a plurality of second sub-elements connected in parallel according to an embodiment of the present disclosure.

FIG. 8 is a schematic structural diagram of a plurality of second sub-elements which are in parallel-series connection according to an embodiment of the present disclosure.

FIG. 9 is a schematic structural diagram of a mineralization filter element unit according to an embodiment of the present disclosure.

FIG. 10 is a schematic structural diagram of another mineralization filter element unit according to an embodiment of the present disclosure.

FIG. 11 is a schematic structural diagram of still another mineralization filter element unit according to an embodiment of the present disclosure.

FIG. 12 is a schematic structural diagram of yet another mineralization filter element unit according to an embodiment of the present disclosure.

FIG. 13 is a schematic structural diagram of water quality parameters of an upstream and a downstream of a mineralization filter element unit according to an embodiment of the present disclosure.

FIG. 14 is a schematic structural diagram of a mineralization water purifier according to an embodiment of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

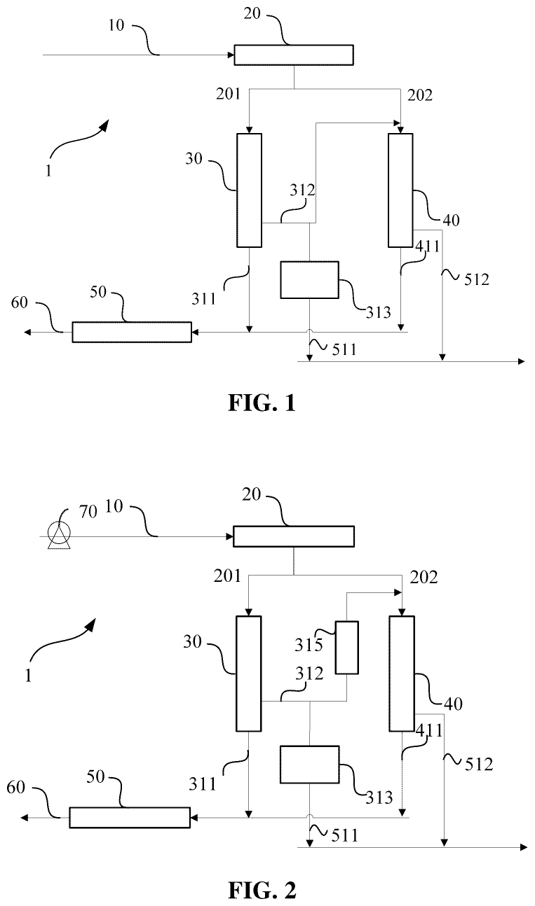

FIG. 1 is a schematic structural diagram of a mineralization waterway system according to an embodiment of the present disclosure.

A mineralization waterway system 1 of this embodiment of the present disclosure can include a water inlet pipeline 10, a first valve body 20, a first filter element unit 30, a second filter element unit 40, a mineralization filter element unit 50, and a water outlet pipeline 60. The water inlet pipeline 10 is connected to the first valve body 20. The first valve body 20 includes a first water outlet end 201 and a second water outlet end 202. The first water outlet end 201 is connected to the first filter element unit 30, and the second water outlet end 202 is connected to the second filter element unit 40. Water outlet ends of both the first filter element unit 30 and the second filter element unit 40 are connected to a water inlet end of the mineralization filter element unit 50, and the water outlet end of the mineralization filter element unit 50 is connected to the water outlet pipeline 60.

In this embodiment of the present disclosure, the mineralization waterway system 1 can include a plurality of gears. A control module in the mineralization waterway system 1 can control the relevant components in the mineralization waterway system 1 to operate according to different gears. For example, according to different gears where the mineralization waterway system is in, the control module can control the water outlet end of the first valve body 20 to be connected to different filter elements to allow incoming water to enter different filter elements through the first valve body 20.

In an optional embodiment, the first valve body 20 can be an electromagnetic valve that can control the inlet water to flow through different gears according to different electrical signals. An electromagnetic valve can be used in conjunction with different circuits to achieve desired control, and the accuracy and flexibility of control can be ensured.

In an optional embodiment, a wastewater pipeline 312 is arranged between a wastewater outlet of the first filter element unit 30 and a water inlet end of the second filter element unit 40. The first filter element unit 30 and the second filter element unit 40 can be connected to each other through the wastewater pipeline 312. In this way, wastewater discharged from the first filter element unit 30 can enter the second filter element unit 40 through the wastewater pipeline 312, and the second filter element unit 40 can filter the wastewater again.

In an optional embodiment, a second valve body 313 is arranged at a first wastewater discharging channel 511 of the first filter element unit 30.

When the mineralization waterway system 1 is in a first gear, the second valve body 313 is closed, and a first waterway is unblocked. The first waterway is unblocked, which means that the mineralization waterway system 1 receives water from the water inlet pipeline 10. The first valve body 20 controls the water to flow out from the first water outlet end 201 to the first filter element unit 30. Purified water obtained by the first filter element unit 30 enters the mineralization filter element unit 50 through a first water filter pipeline 311 for mineralization. Water (i.e. mineralized water) mineralized by the mineralization filter element unit 50 is discharged through the water outlet pipeline 60. Meanwhile, wastewater discharged from the first filter element unit 30 can enter the second filter element unit 40 for filtration, and then purified water obtained by the second filter element unit 40 flows through a second water filter pipeline 411 into the mineralization filter element unit 50 for mineralization.

Referring to FIG. 2 together, a check valve 315 can further be arranged at the wastewater pipeline 312. The check valve 315 can be configured to: allow the wastewater discharged from the first filter element unit 30 to flow to the water inlet end of the second filter element unit 40 and prevent the wastewater in the wastewater pipeline 312 from flowing back. On the one hand, it can improve the efficiency of water filtration of the second filter element unit 40, and on the other hand, it can avoid the wastewater from flowing back to pollute the first filter element unit 30 or the purified water obtained by the first filter element unit 30.

In an optional embodiment, when the mineralization waterway system 1 is in the first gear, since the second valve body 313 is closed, the wastewater discharged from the first filter element unit 30 cannot be discharged through the second valve body 313, but can only flow into the second filter element unit 40 through the wastewater pipeline 312 and the check valve 315. The purified water obtained by the second filter element unit 40 enters the mineralization filter element unit 50 for mineralization through the second filter water pipeline 411.

From this, it can be seen that when the first valve body 20 is in the first gear, the purified water obtained by the first filter element unit 30 flows towards the mineralization filter element unit 50; the wastewater discharged from the first filter element unit 30 enters the second filter element unit 40; and the purified water obtained by the second filter element unit 40 flows towards the mineralization filter element unit 50, and finally flows through the mineralization filter element unit 50 to the water outlet pipeline 60. Namely, the water flowing out from the water outlet pipeline 60 includes the water from the first filter element unit 30 and the water from the second filter element unit 40. In this case, a volume of the water flowing out from the water outlet pipeline 60 is different from a volume of the water obtained separately by the first filter element unit 30 or a volume of the water obtained separately by the second filter element unit 40.

In an optional embodiment, the mineralization waterway system 1 can further include a second gear, a third gear, and a fourth gear. Different gears correspond to different water flowing paths.

When the mineralization waterway system 1 is in the second gear, the first water outlet end 201 of the first valve body 20 is connected to the first filter element unit 30; the second valve body 313 is opened; the check valve 315 is closed; and a second waterway is unblocked. The second waterway is unblocked, which means that after water flows from the water inlet pipeline 10 into the first valve body 20, the first valve body 20 causes the water flowing in through the water inlet pipeline 10 to flow out from the first water outlet end 201 to the first filter element unit 30. Purified water obtained by the first filter element unit 30 flows through the first water filter pipeline 311 into the mineralization filter element unit 50 for mineralization, and mineralized water is discharged through the water outlet pipeline 60. Meanwhile, wastewater discharged from the first filter element unit 30 is discharged in sequence through the second valve body 313 and the first wastewater discharging channel 511. From this, it can be seen that when the mineralization waterway system 1 is in the second gear, the mineralization waterway system 1 can only filter water through the first filter element unit 30 and the mineralization filter element unit 50.

When the mineralization waterway system 1 is in the third gear position, the second water outlet end 202 of the first valve body 20 is connected to the second filter element unit 40, and a third waterway is unblocked. The third waterway is unblocked, which means that after water flows from the water inlet pipeline 10 into the first valve body 20, the first valve body 20 causes the water flowing in through the water inlet pipeline 10 to flow out from the second water outlet end 202 to the second filter element unit 40. Purified water obtained by the second filter element unit 40 flows through the second water filter pipeline 411 into the mineralization filter element unit 50 for mineralization, and mineralized water is discharged through the water outlet pipeline 60. Meanwhile, wastewater discharged from the second filter element unit 40 is discharged through a second wastewater discharging channel 512. From this, it can be seen that when the mineralization waterway system 1 is in the third gear, the mineralization waterway system 1 can only filter water through the second filter element unit 40 and the mineralization filter element unit 50.

When the mineralization waterway system 1 is in the fourth gear, the first water outlet end 201 of the first valve body 20 is connected to the first filter element unit 30; the second water outlet end 202 of the first valve body 20 is connected to the second filter element unit 40; the second valve body 313 is closed; and a fourth waterway is unblocked. The fourth waterway is unblocked, which means that after water enters the first valve body 20 from the water inlet pipeline 10, the water flows out from the first water outlet end 201 to the first filter element unit 30, and at the same time flows out from the second water outlet end 202 to the second filter element unit 40. Purified water obtained by the first filter element unit 30 flows through the first water filter pipeline 311 into the mineralization filter element unit 50 for mineralization, and purified water obtained by the second filter element unit 40 flows through the second water filter pipeline 411 into the mineralization filter element unit 50 for mineralization. Meanwhile, wastewater discharged from the first filter element unit 30 is discharged in sequence through the second valve body 313 and the first wastewater discharging channel 511, and wastewater discharged from the second filter element unit 40 is discharged through the second wastewater discharging channel 512. From this, it can be seen that when the mineralization waterway system 1 is in the fourth gear, the mineralization waterway system 1 can simultaneously filter water through the first filter element unit 30 and the second filter element unit 40, and the purified water obtained by the first filter element unit 30 and the purified water obtained by the second filter element unit 40 flow out simultaneously. The wastewater discharged from the first filter element unit 30 and the wastewater discharged from the second filter element unit 40 can be discharged respectively from the first wastewater discharging channel 511 and the second wastewater discharging channel 512.

In an optional embodiment, the water inlet pipeline 10 can include a variable frequency water pump. The variable frequency water pump can control a water outlet volume of the water inlet pipeline 10. A pump rate of the variable frequency water pump varies according to different gears of the mineralization waterway system 1. For example, if a user turns on a tap and selects the first gear, a control module of the mineralization waterway system 1 can control the variable frequency water pump to have a first pump rate, and the water inlet pipeline 10 can supply water at a first flow speed. If the user selects the second gear, the control module of the mineralization waterway system 1 can control the variable frequency water pump to have a second pump rate, and the water inlet pipeline 10 can supply water at a second flow speed. If the user selects the third gear, the control module of the mineralization waterway system 1 can control the variable frequency water pump to have a third pump rate, and the water inlet pipeline 10 can supply water at a third flow speed. If the user selects the fourth gear, the control module of the mineralization waterway system 1 can control the variable frequency water pump to have a fourth pump rate, and the water inlet pipeline 10 can supply water at a fourth flow speed.

The control module can transmit a control signal to the variable frequency water pump, the first valve body, and the second valve body, to control the variable frequency water pump, the first valve body, and the second valve body to cooperate with each other, thus achieving corresponding functions.

In this embodiment of the present disclosure, the first valve body can be connected to a plurality of filter elements respectively, so that the water in the water inlet pipeline can enter different filter elements respectively. Meanwhile, the first filter element unit is further connected to the second filter element unit. Under the circumstance, the water in the water inlet pipeline can enter the second filter element unit through the first filter element unit and is filtered by the second filter element unit. A plurality of water filtering channels provided in the embodiments solve a problem that a flow rate of the existing mineralization waterway system cannot be adjusted.

In the existing mineralization waterway system, once the filter element fails, the entire filter element needs to be replaced, resulting in high filter element replacement costs.

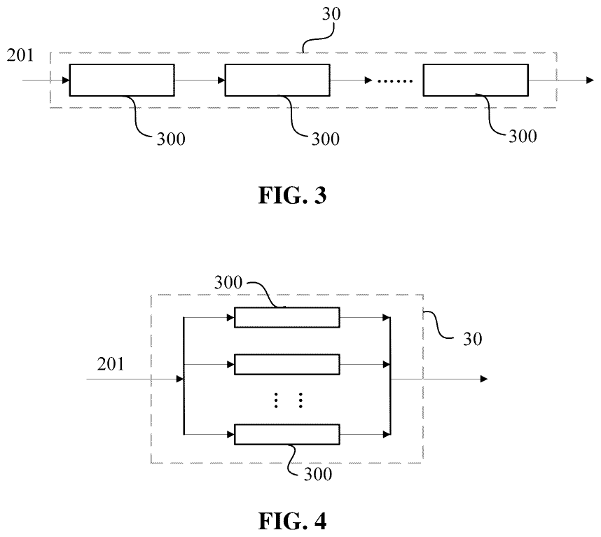

Referring to FIG. 3 to FIG. 5 together, the first filter element unit 30 is provided with a plurality of first filter sub-elements 300, and the plurality of first filter sub-elements 300 are connected in series or in parallel in sequence or are in parallel-series connection in sequence. The first filter element unit 30 can include a Reverse Osmosis membrane (RO membrane).

Referring to FIG. 3, a schematic structural diagram of a plurality of filter sub-elements connected in series in sequence is shown. The plurality of first filter sub-elements 300 are connected in series in sequence, which means that a purified water outlet end of a first filter sub-element 300 is connected to a water inlet end of an adjacent first filter sub-element 300, or a concentrated water outlet end of the first filter sub-element 300 is connected to a water inlet end of the adjacent first filter sub-elements 300. In short, raw water flows through the plurality of first filter sub-elements 300 one by one in the first filter element unit 30, to finally obtain concentrated water and purified water.

Referring to FIG. 4, a schematic structural diagram of a plurality of filter sub-elements connected in parallel is shown. The plurality of first filter sub-elements 300 are connected in parallel, which means that water to be treated is divided into a plurality of streams of water which correspondingly enter the plurality of first filter sub-elements 300. After the water is treated by the plurality of first filter sub-elements 300, concentrated water and purified water are obtained.

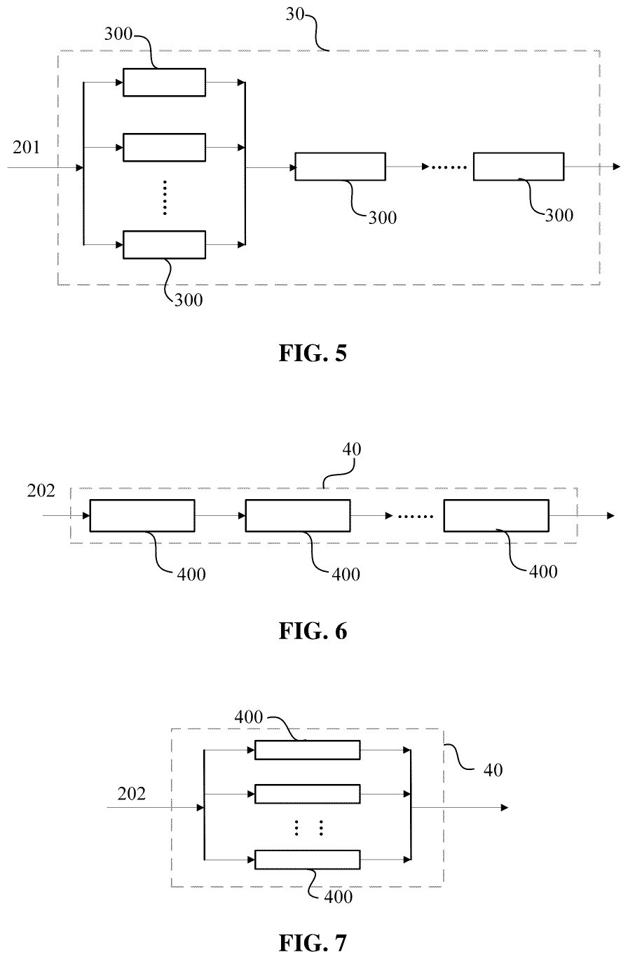

Referring to FIG. 5, a schematic structural diagram of a plurality of first filter sub-elements which are in parallel-series connection is shown. The parallel-series connection of the plurality of first filter sub-elements 300 includes series connection and parallel connection. One part of the first filter sub-elements 300 can be connected in parallel first, and then the other part of the first filter sub-elements 300 can be connected in series in sequence.

It should be noted that regardless of whether it is series connection, parallel connection, or parallel-series connection, this embodiment of the present disclosure does not impose any limitation on the quantity of the first filter sub-elements 300. The quantity can be set or adjusted according to an actual need.

In the above optional embodiment, by the arrangement of the plurality of first filter sub-elements 300, when one of the first filter sub-elements 300 fails, only the failed first filter sub-element 300 is replaced, instead of replacing a non-failed first filter sub-element 300, thereby greatly reducing the filter element replacement cost.

Referring to FIG. 6 to FIG. 8 together, the second filter element unit 40 is provided with a plurality of second filter sub-elements 400, and the plurality of second filter sub-elements 400 are connected in series or in parallel in sequence or are in parallel-series connection in sequence. The second filter element unit 40 can include a Reverse Osmosis membrane (RO membrane).

Referring to FIG. 6, a schematic structural diagram of a plurality of second filter sub-elements connected in series in sequence is shown. The plurality of second filter sub-elements 400 are connected in series in sequence, which means that a purified water outlet end of a second filter sub-element 400 is connected to a water inlet end of an adjacent second filter sub-element 400, or a concentrated water outlet end of the second filter sub-element 400 is connected to a water inlet end of the adjacent second filter sub-elements 400. In short, concentrated water generated by the second filter sub-elements 400 flows through the plurality of second filter sub-elements 400 one by one in the second filter element unit 200, to finally obtained concentrated water and purified water.

Referring to FIG. 7, a schematic structural diagram of a plurality of second sub-elements connected in parallel is shown. The plurality of second filter sub-elements 400 are connected in parallel, which means that concentrated water generated by the first filter element unit 30 is divided into a plurality of streams of water which correspondingly enter the plurality of second filter sub-elements 400. After the concentrated water is treated by the plurality of second filter sub-elements 400, concentrated water and purified water are obtained.

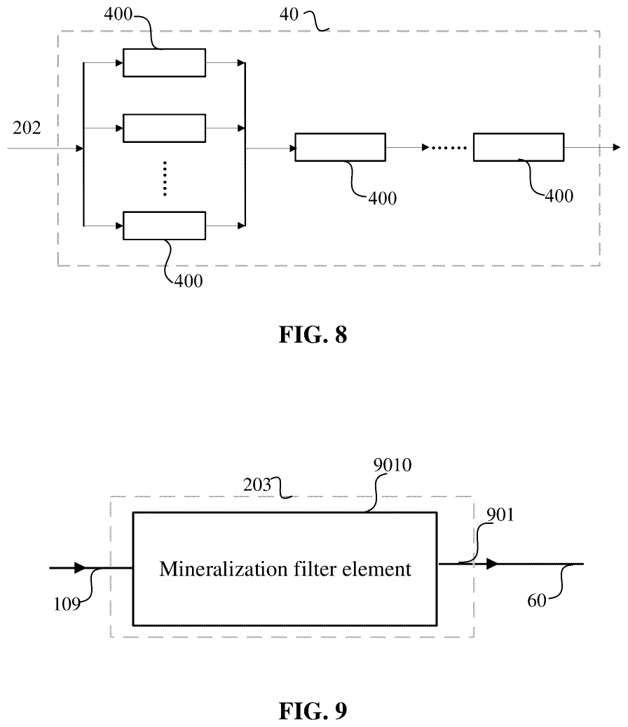

Referring to FIG. 8, a schematic structural diagram of a plurality of second filter sub-elements which are in parallel-series connection is shown. The parallel-series connection of the plurality of second filter sub-elements 400 includes series connection and parallel connection. One part of the second filter sub-elements 400 can be connected in parallel first, and then the other part of the second filter sub-elements 400 can be connected in series in sequence.

It should be noted that regardless of whether it is series connection, parallel connection, or parallel-series connection, this embodiment of the present disclosure does not impose any limitation on the quantity of the second filter sub-elements 400. The quantity can be set or adjusted according to an actual need.

In the above optional embodiment, by the arrangement of the plurality of second filter sub-elements 400, when one of the second filter sub-elements 400 fails, only the failed second filter sub-element 400 is replaced, instead of replacing a non-failed first second sub-element 400, thereby greatly reducing the filter element replacement cost.

Since the first filter element unit 30 and the second filter element unit 40 can filter out all substances in the water, pure water without any beneficial elements is not healthy water in a sense and does not conform to the concept of healthy water. Therefore, the present disclosure uses the mineralization filter element unit 50 to mineralize the purified water, thereby producing mineralized water that is good for a human body.

Referring to FIG. 9, the mineralization filter element unit 50 includes a mineralization pipeline 901, and a mineralization filter element 9010 is arranged on the mineralization pipeline 901.

The mineralization pipeline 901 is a channel through which water flows, to ensure smooth and efficient flowing through of water, without introducing any pollutants.

The mineralization filter element 9010 is responsible for adding beneficial minerals into water, to enhance the taste and nutritional value of the water. The mineralization filter element 9010 can be made of various materials, including but not limited to maifanite, tourmaline, weakly alkaline mineralization spheres, and the like.

In practical applications, when flowing through the mineralization filter element unit 50, pure water flowing out of a pure water side of the first filter element unit 30 and/or the second filter element unit 40, pure water can first enter the mineralization pipeline 901 and then flow through the mineralization filter element 9010. The water is in contact with and exchanges with a material in the mineralization filter element 9010, thereby absorbing beneficial minerals. After mineralization, the taste and nutritional value of the water can be improved, so that the water is more suitable for drinking.

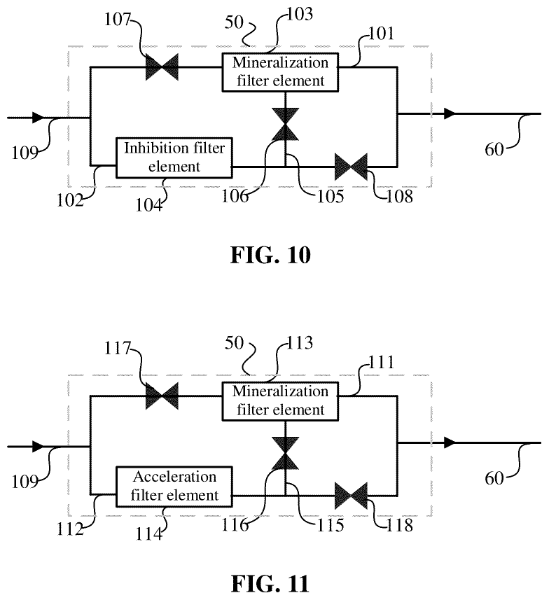

As shown in FIG. 10, the mineralization filter element unit 50 includes a mineralization pipeline 101 and an inhibition pipeline 102. The mineralization pipeline 101 is provided with a mineralization filter element 103, and the inhibition pipeline 102 is provided with an inhibition filter element 104.

In an optional embodiment, the mineralization pipeline 101 and the inhibition pipeline 102 are arranged in parallel and can simultaneously output water. Specifically, the mineralization pipeline 101 and the inhibition pipeline 102 are connected in parallel between the water inlet pipeline 109 of the mineralization filter element unit 50 and the water outlet pipeline 60 of the mineralization filter element unit 50. The water inlet pipeline 109 can be connected to the mineralization pipeline 101 and the inhibition pipeline 102 through a three-way valve or a flow divider valve, and the mineralization pipeline 101 and the inhibition pipeline 102 can be connected to the water outlet pipeline 60 through a three-way valve. When the mineralization pipeline 101 and the inhibition pipeline 102 simultaneously output water, the water from the mineralization pipeline 101 and the inhibition pipeline 102 can be mixed and then discharged through the water outlet pipeline 60.

The mineralization filter element 103 is arranged in the mineralization pipeline 101, and the mineralization filter element 103 can release (dissolve) minerals into the water flowing therethrough, thereby making the water output from the mineralization pipeline 101 contain minerals, to meet a requirement of people for mineralized drinking water. The inhibition filter element 104 is arranged in the inhibition pipeline 102, and the inhibition filter element 104 can release an inhibitory substance into the water flowing therethrough. When the water containing the inhibitory substance flows through the mineralization filter element 103, the inhibitory substance can inhibit the dissolution of the minerals in the mineralization filter element 103, thereby avoiding a situation that the mineral content of the water is high.

In an optional embodiment, the mineralization filter element unit 50 further includes a serially-connected switching pipeline 105. The serially-connected switching pipeline 105 is arranged between the mineralization pipeline 101 and the inhibition pipeline 102 and is configured to connect the inhibition filter element 104 to the mineralization filter element 103 in series. An output end of the serially-connected switching pipeline 105 is connected to the mineralization pipeline 101 or the mineralization filter element 103, and an input end of the serially-connected switching pipeline 105 is connected to the inhibition pipeline 102 or the inhibition filter element 104.

The output end of the serially-connected switching pipeline 105 is connected to the mineralization pipeline 101 or the mineralization filter element 103, and the input end of the serially-connected switching pipeline 105 is connected to the inhibition pipeline 102 or the inhibition filter element 104, so that a mineralization structure in which the inhibition filter element 104 is located upstream and the mineralization filter element 103 is located downstream can be formed, and the water containing the inhibitory substance is made to flow through a waterway of the mineralization filter element 103.

In specific implementation, to prevent a high mineral content of the water, the water containing the inhibitory substance can flow through the mineralization filter element 103 through the serially-connected switching pipeline 105 to inhibit the release of the minerals from the mineralization filter element 103 and meet a requirement for reducing the mineral content of the water. When the mineralization filter element 103 is in a soaked state, for example, if the water in the mineralization pipeline 101 flows too slowly, or if outputting of water stops, or after outputting of water stops for a set duration, it can cause the mineral content of the water (especially in the mineralization filter element 103) to be too high. By using the serially-connected switching pipeline 105, the water containing the inhibitory substance can enter the mineralization filter element 103, thereby inhibiting the mineralization filter element 103 in the soaked state from releasing minerals and avoiding an excessive mineral content of the water. The soaked state described in this embodiment means a situation that a flow rate in the filter element is less than a design threshold, including a situation that water stops flowing, the flowing is slow, or the like.

In an optional embodiment, a first control valve 106 is arranged at the serially-connected switching pipeline 105.

The first control valve 106 has a state of allowing water to flow through and a state of not allowing water to flow through. In specific applications, the first control valve 106 can also be a flow valve. Since the first control valve 106 is arranged at the serially-connected switching pipeline 105, it is possible to control whether the water can flow through the serially-connected switching pipeline 105 from the inhibition filter element 104 to the mineralization filter element 103. For example, when the mineralization filter element 103 is in the soaked state, the first control valve 106 can be made in the state of allowing water to flow through. Therefore, the water can flow from the inhibition filter element 104 to the mineralization filter element 103 through the serially-connected switching pipeline 105, thereby inhibiting the mineralization filter element 103 from releasing the minerals, to reduce the mineral content of the water, prevent the mineral content from exceeding a set standard, and control the mineral content in a safe standard range. When a flow rate of the water flowing through the mineralization pipeline 101 exceeds a set flow rate, a concentration of the minerals in the water flowing through the mineralization filter element 103 cannot exceed a set standard. When the mineral content of the water does not need to be reduced, the first control valve 106 can be made in the state of not allowing water to flow through.

In an optional embodiment, the mineralization filter element unit 50 further includes a second control valve 107. The second control valve 107 is arranged at the mineralization pipeline 101 and is located at an upstream end of the mineralization filter element 103.

The second control valve 107 is configured to control blocking and unblocking or/and a flow rate of the mineralization pipeline 101. By controlling opening or closing of the second control valve 107, it is possible to determine whether to convey water to the mineralization filter element 103. The flow rate of the mineralization pipeline 101 is controlled through the second control valve 107, so that an amount of minerals released by the mineralization filter element 103 into water per unit volume can be controlled. Specifically, when the flow rate of water in the mineralization pipeline 101 is greater than a set flow rate, the mineral content of water per unit volume can decrease. When the flow rate of water in the mineralization pipeline 101 is less than the set flow rate, the mineral content of water per unit volume can increase. Therefore, the flow rate of the mineralization pipeline 101 can be adjusted through the second control valve 107, thereby adjusting the mineral content of the water in the mineralization pipeline 101.

The output end of the serially-connected switching pipeline 105 is connected between the second control valve 107 and the mineralization filter element 103. In this way, the output end of the serially-connected switching pipeline 105 is connected to an upstream end of the mineralization filter element 103, which can achieve flowing of water in the serially-connected switching pipeline 105 to the mineralization filter element 103.

In an optional embodiment, the mineralization filter element unit 50 further includes a third control valve 108. The third control valve 108 is arranged at the inhibition pipeline 102 and is located at a downstream end of the inhibition filter element 104.

The third control valve 108 is configured to control blocking and unblocking or/and a flow rate of the inhibition pipeline 102. The input end of the serially-connected switching pipeline 105 is connected between the inhibition filter element 104 and the third control valve 108. In this way, the input end of the serially-connected switching pipeline 105 is connected to the downstream end of the inhibition filter element 104. When the third control valve 108 is closed, and the first control valve 106 is opened, the water containing the inhibitory substance can flow to the serially-connected switching pipeline 105, and then the water containing the inhibitory substance flows to the mineralization filter element 103.

By controlling the opening or closing of the second control valve 107 and the opening or the closing of the third control valve 108, as well as controlling the state of the first control valve 106 of whether to allow water to flow through, it is possible to achieve that the mineralization pipeline 101 and the inhibition pipeline 102 output water simultaneously or separately, and the water flowing through the inhibition filter element 104 can enter the mineralization filter element 103 through the serially-connected switching pipeline 115.

For example, when the mineralization pipeline 101 and the inhibition pipeline 102 need to output water simultaneously, the second control valve 107 and the third control valve 108 can be controlled to be opened, and the first control valve 106 can be closed. In this case, the serially-connected switching pipeline 105 is blocked, and the mineralization pipeline 101 and the inhibition pipeline 102 are connected in parallel. The water containing the minerals in the mineralization pipeline 101 and the water containing the inhibitory substance in the inhibition pipeline 102 can be mixed in the water outlet pipeline 60 and then discharged.

For another example, when the mineralization pipeline 101 needs to output water separately, the second control valve 107 can be controlled to be opened, and the first control valve 106 and the third control valve 108 can be closed. In this case, the mineralization pipeline 101 is unblocked, and the inhibition pipeline 102 and the serially-connected switching pipeline 105 are both blocked. The water containing the minerals in the mineralization pipeline 101 can be discharged through the water outlet pipeline 60.

For still another example, when the mineralization filter element 103 is in the soaked state, the second control valve 107 and the third control valve 108 can be controlled to be closed, and the first control valve 106 can be opened. In this case, the inhibition filter element 104 and the mineralization filter element 103 are connected to each other through the serially-connected switching pipeline 105, and the water containing the inhibitory substance can flow to the mineralization filter element 103 through the serially-connected switching pipeline 105.

In an optional embodiment, the first control valve 106, the second control valve 107, and the third control valve 108 are all electromagnetic valves. Of course, in other embodiments, the first control valve 106, the second control valve 107, and the third control valve 108 can further use other valves.

In an optional embodiment, the mineralization filter element 103 includes a zinc-containing filter material (e.g., smithsonite and hydrozincite), and the inhibition filter element 104 includes an alkaline filter material (e.g., magnesite, brucite, sepiolite, and calcite). Zinc plays an indispensable role in cell replication, immune activity, and tissue repair and growth, and is a key element in growth, reproductive genetics, immune systems, and bone metabolism. Therefore, configuring the mineralization filter element 103 to include the zinc-containing filter material can release mineral zinc into water, which is beneficial to the health of people. In addition, water with a pH value between 7.0 and 9.0 is the best for the health of a human body. Configuring the inhibition filter element 104 to include the alkaline filter material is beneficial for maintaining the water within the pH range of 7.0 to 9.0.

It should be noted that zinc is one of the essential trace elements for the human body, and it helps growth and can further participate in vitamin metabolism. However, when a zinc content of drinking water exceeds a standard, it can lead to excessive zinc intake in a human body, which can cause harms to the human body, such as zinc poisoning and abnormal lipid metabolism. Therefore, the inhibition filter element 104 is configured to inhibit excessive release of zinc, a high zinc concentration can be avoided.

It can be understood that in other embodiments, the mineralization filter element 103 can further include a filter material containing other minerals, such as copper, calcium, magnesium, potassium, and strontium. It should be noted that when the mineralization filter element 103 includes the filter material containing other minerals, a corresponding inhibition filter material is matched in the inhibition filter element 104.

In an optional embodiment, the mineralization filter element 103 includes a first alkaline filter material, and the inhibition filter element 104 includes a second alkaline filter material. An alkalinity of the first alkaline filter material is less than an alkalinity of the second alkaline filter material, and the alkalinity of the second alkaline filter material is greater than the alkalinity of the first alkaline filter material. Therefore, the second alkaline filter material can be configured to suppress dissolution of an alkaline substance from the first alkaline filter material. For example, the first alkaline filter material (weakly alkaline) contains maifanite or tourmaline, and the second alkaline filter material (strongly alkaline) contains zinc with a high concentration and magnesium with a high concentration.

Weakly alkaline ores are arranged in the first alkaline filter material, and strongly alkaline ores are arranged in the second alkaline filter material. When water flows through the first alkaline filter material first, an alkaline substance precipitated from the first alkaline filter material can increase the pH value of the water. Afterwards, when the water flows into the inhibition filter element 104, since the pH value of the water has been increased by the first alkaline filter material, the precipitation of the minerals such as zinc and copper in the second alkaline filter material can be inhibited to an extent (usually because the solubility or precipitation rate of these minerals decreases at a higher pH value).

By using the above filter element unit 50, when the water has a high mineral content, the mineral content of the water can be reduced by inhibiting the release or dissolution of the minerals in the mineralization filter element through the inhibition filter element.

As shown in FIG. 11, the mineralization filter element unit 50 includes a mineralization pipeline 111 and an acceleration pipeline 112. The mineralization pipeline 111 is provided with a mineralization filter element 113, and the acceleration pipeline 112 is provided with an acceleration filter element 114.

In an optional embodiment, the mineralization pipeline 111 and the acceleration pipeline 112 are arranged in parallel and can simultaneously output water. Specifically, the mineralization pipeline 111 and the acceleration pipeline 112 are connected in parallel between the water inlet pipeline 109 of the mineralization filter element unit 50 and the water outlet pipeline 60 of the mineralization filter element unit 50. The water inlet pipeline 109 can be connected to the mineralization pipeline 111 and the acceleration pipeline 112 through a three-way valve or a flow divider valve, and the mineralization pipeline 111 and the acceleration pipeline 112 can be connected to the water outlet pipeline 60 through a three-way valve. When the mineralization pipeline 111 and the acceleration pipeline 112 simultaneously output water, the water from the mineralization pipeline 111 and the acceleration pipeline 112 can be mixed and then discharged through the water outlet pipeline 60.

The mineralization filter element 113 is arranged in the mineralization pipeline 111, and the mineralization filter element 113 can release (dissolve) minerals into the water flowing therethrough, thereby making the water output from the mineralization pipeline 111 contain minerals, to meet a requirement of people for mineralized drinking water. The acceleration filter element 114 is arranged in the acceleration pipeline 112, and the acceleration filter element 114 can release an accelerant into the water flowing therethrough. When the water containing the accelerant flows through the mineralization filter element 113, the accelerant can accelerate the dissolution of the minerals in the mineralization filter element 113, thereby increasing the mineral content of the water.

In an optional embodiment, the mineralization filter element unit 50 further includes a serially-connected switching pipeline 115. The serially-connected switching pipeline 115 is arranged between the mineralization pipeline 111 and the acceleration pipeline 112 and is configured to connect the acceleration filter element 114 to the mineralization filter element 113 in series. An output end of the serially-connected switching pipeline 115 is connected to the mineralization pipeline 111 or the mineralization filter element 113, and an input end of the serially-connected switching pipeline 115 is connected to the acceleration pipeline 112 or the acceleration filter element 114.

The output end of the serially-connected switching pipeline 115 is connected to the mineralization pipeline 111 or the mineralization filter element 113, and the input end of the serially-connected switching pipeline 115 is connected to the acceleration pipeline 112 or the acceleration filter element 114, so that a mineralization structure in which the acceleration filter element 114 is located upstream and the mineralization filter element 113 is located downstream can be formed, and the water containing the accelerant is made to flow through a waterway of the mineralization filter element 113.

Since the water containing the accelerant flows into the mineralization filter element 113, the accelerant can accelerate the release of the minerals from the mineralization filter element 113, thereby increasing the mineral content of the water and then avoiding that the mineral content of the water does not meet a standard. For example, when the flow rate of the water in the mineralization pipeline 111 exceeds a set flow rate (i.e., the flow rate of the water is large), the flow speed of the water increases, and the release amount of the minerals in water per unit volume can decrease. By using the serially-connected switching pipeline 115, the water containing the accelerant flows into the mineralization filter element 113 to accelerate the release of the minerals from the mineralization filter element 113, which can increase the mineral content of the water. When the mineralization filter element 113 has been used for a period of time and reaches the middle to late stage of its service life, the performance of the mineralization filter element 113 for releasing minerals decreases. The accelerant is used to accelerate the release of minerals from the mineralization filter element 113, so that the mineral content of the water can be effectively increased, and the minerals in the water can meet a standard. Furthermore, the service life of the mineralization filter element 113 can be prolonged.

In an optional embodiment, a first control valve 116 is arranged at the serially-connected switching pipeline 115.

The first control valve 116 has a state of allowing water to flow through and a state of not allowing water to flow through. In specific applications, the first control valve 116 can also be a flow valve. Since the first control valve 116 is arranged at the serially-connected switching pipeline 115, it is possible to control whether the water can flow through the serially-connected switching pipeline 115 from the acceleration filter element 114 to the mineralization filter element 113. When the water in the mineralization pipeline 111 has a large flow rate, or when the mineralization filter element 113 has reached the middle to late stage of its service life, the first control valve 116 can be in the state of allowing water to flow through. In this case, the water can flow from the acceleration filter element 114 to the mineralization filter element 113 through the serially-connected switching pipeline 115, thereby increasing the release amount of minerals from the mineralization filter element 113, to increase the mineral content of the water, prevent the mineral content from being less than a set standard, and control the mineral content in a safe standard range. When the flow rate of the water in the mineralization pipeline 111 is less than a set flow rate, or when the mineralization filter element 113 has reached the middle to late stage of its service life, a concentration of the minerals in the water that flows through the mineralization filter element 113 cannot be less than a set standard. When the mineral content of the water meets the standard, the first control valve 116 can be in the state of not allowing water to flow through.

In an optional embodiment, the mineralization filter element unit 50 further includes a second control valve 117. The second control valve 117 is arranged at the mineralization pipeline 111 and is located at an upstream end of the mineralization filter element 113.

The second control valve 117 is configured to control blocking and unblocking or/and a flow rate of the mineralization pipeline 111. By controlling opening or closing of the second control valve 117, it is possible to determine whether to convey water to the mineralization filter element 113. The flow rate of the mineralization pipeline 111 is controlled through the second control valve 117, so that an amount of minerals released by the mineralization filter element 113 into water per unit volume can be controlled. Specifically, when the flow rate of water in the mineralization pipeline 111 is greater than a set flow rate, the mineral content of water per unit volume can decrease. When the flow rate of water in the mineralization pipeline 111 is less than the set flow rate, the mineral content of water per unit volume can increase. Therefore, the flow rate of the mineralization pipeline 111 can be adjusted through the second control valve 117, thereby adjusting the mineral content of the water in the mineralization pipeline 111.

The output end of the serially-connected switching pipeline 115 is connected between the second control valve 117 and the mineralization filter element 113. In this way, the output end of the serially-connected switching pipeline 115 is connected to an upstream end of the mineralization filter element 113, which can achieve flowing of water in the serially-connected switching pipeline 115 to the mineralization filter element 113.

In an optional embodiment, the mineralization filter element unit 50 further includes a third control valve 118. The third control valve 118 is arranged at the acceleration pipeline 112 and is located at a downstream end of the acceleration filter element 114.

The third control valve 118 is configured to control blocking and unblocking or/and a flow rate of the acceleration pipeline 112. The input end of the serially-connected switching pipeline 115 is connected between the acceleration filter element 114 and the third control valve 118. In this way, the input end of the serially-connected switching pipeline 115 is connected to the downstream end of the acceleration filter element 114. When the third control valve 118 is closed, and the first control valve 116 is opened, the water containing the accelerant can flow to the serially-connected switching pipeline 115, and then the water containing the accelerant flows to the mineralization filter element 113.

By controlling the opening or closing of the second control valve 117 and the opening or the closing of the third control valve 118, as well as controlling the state of the first control valve 116 of whether to allow water to flow through, it is possible to achieve that the mineralization pipeline 111 and the acceleration pipeline 112 output water simultaneously or separately, and the water flowing through the acceleration filter element 114 can enter the mineralization filter element 113 through the serially-connected switching pipeline 115.

For example, when the mineralization pipeline 111 and the acceleration pipeline 112 need to output water simultaneously, the second control valve 117 and the third control valve 118 can be controlled to be opened, and the first control valve 116 can be closed. In this case, the serially-connected switching pipeline 115 is blocked, and the mineralization pipeline 111 and the acceleration pipeline 112 are connected in parallel. The water containing the minerals in the mineralization pipeline 111 and the water containing the accelerant in the acceleration pipeline 112 can be mixed in the water outlet pipeline 60 and then discharged.

For another example, when the mineralization pipeline 111 needs to output water separately, the second control valve 117 can be controlled to be opened, and the first control valve 116 and the third control valve 118 can be closed. In this case, the mineralization pipeline 111 is unblocked, and the acceleration pipeline 112 and the serially-connected switching pipeline 115 are both blocked. The water containing the minerals in the mineralization pipeline 111 can be discharged through the water outlet pipeline 60.

For another example, when the mineralization filter element 113 is in the middle to late stage of its service life, the first control valve 116 can be controlled to be opened, and the second control valve 117 and the third control valve 118 can be controlled to be closed. In this case, the acceleration filter element 114 and the mineralization filter element 113 are connected through the serially-connected switching pipeline 115, and the water containing the accelerant can flow to the mineralization filter element 113 through the serially-connected switching pipeline 115, thereby accelerating the release of minerals from the mineralization filter element 113, to make the minerals in the water meet the standard. Even if the mineralization filter element 113 is in the middle to late stage of its lifespan (the dissolution rate of minerals decreases), by using the acceleration filter element 114, the dissolution rate of the minerals in the mineralization filter element 113 is maintained within a set range, and the service life of the mineralization filter element 113 can be prolonged. Or, even in a large flow rate, the first control valve 116 can be controlled to be opened, and the second control valve 117 and the third control valve 118 can be controlled to be closed, so that the minerals in the water can meet the standard at the large flow rate.

In an optional embodiment, the first control valve 116, the second control valve 117, and the third control valve 118 are all electromagnetic valves. Of course, in other embodiments, the first control valve 116, the second control valve 117, and the third control valve 118 can further use other valves.

In an optionally embodiment, the mineralization filter element 113 includes a metasilicic-acid-containing filter material, and the acceleration filter element 114 includes an alkaline filter material. Silicon is one of the essential trace elements for a human body, and it tends to decrease significantly with age in the human body. Modern medicine has shown that silicon has an impact on synthesis of bone tissues and is related to bone growth and bone structures. Silicon plays a physiological role in the process of bone calcification and can promote bone growth. Insufficient intake of silicon can lead to a decrease in bone calcium content. Lack of silicon in a body can further lead to growth retardation, resulting in skeletal abnormalities, deformities (especially in the skull), and underdeveloped teeth or enamel. Silicon can further enhance the strength of elastic fibers of blood vessels, especially intimal elastic layers, thereby forming a barrier that effectively hinders lipid invasion. This property enables silicon to have an effect of resisting atherosclerosis, can maintain the integrity of the elastic fibers and mesenchyme, and thus prevent formation of atherosclerotic plaques. Silicon can further remove fat deposited on inner walls of blood vessels. This mechanism can alleviate arteriosclerosis and cardiovascular and heart diseases.

Silicon required by a human body generally comes from water, and the silicon in the water exists in the form of metasilicic acid, so that it is easily absorbed by the human body and the skin. Therefore, since the mineralization filter element 113 contains the metasilicic-acid-containing filter material, the mineralization filter element 113 can release metasilicic acid into the water, which is beneficial to the health of the human body.

In addition, water with a pH value between 7.0 and 9.0 is the best for the health of the human body. Configuring the acceleration filter element 114 to include the alkaline filter material is beneficial for maintaining the water within the pH range of 7.0 to 9.0, which is then beneficial to the health of the human body.

It can be understood that in other embodiments, the mineralization filter element 113 can further include a filter material containing other minerals, such as copper, calcium, magnesium, potassium, strontium, and zinc. It should be noted that when the mineralization filter element 113 includes the filter material containing other minerals, a corresponding acceleration filter material is matched in the acceleration filter element 114.

In an optional embodiment, the mineralization filter element 113 includes maifanite, and the acceleration filter element 114 includes periclase. By using the maifanite as the filter material of the mineralization filter element 113, the metasilicic acid that is beneficial for the human body can be released, without producing harmful substances to the human body.

By using the above filter element unit 50, when the water has a low mineral content, the mineral content of the water can be increased by accelerating the release or dissolution of the minerals in the mineralization filter element through the acceleration filter element.

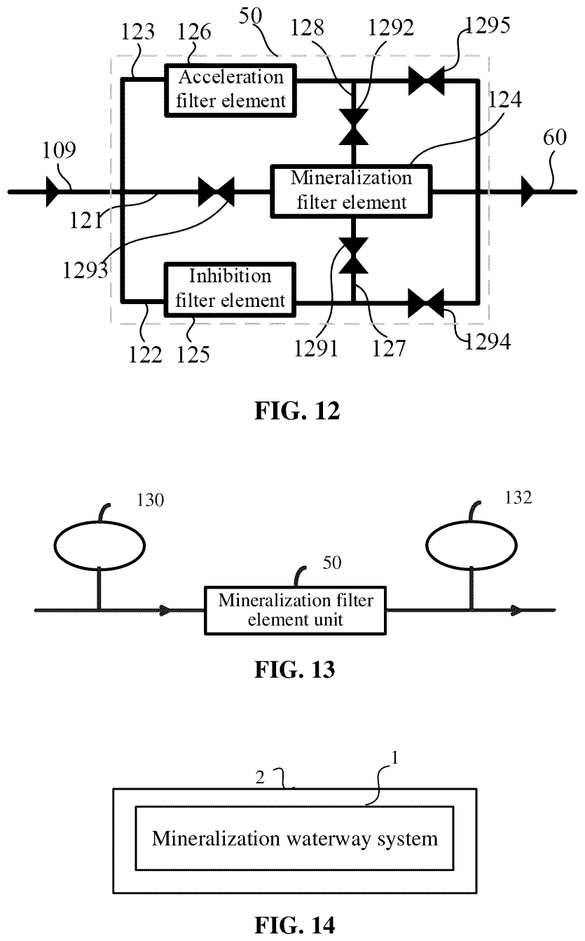

As shown in FIG. 12, the mineralization filter element unit 50 includes a mineralization pipeline 121, an inhibition pipeline 122, and an acceleration pipeline 123. The mineralization pipeline 121 is provided with a mineralization filter element 124. The inhibition pipeline 122 is provided with an inhibition filter element 125. The acceleration pipeline 123 is provided with an acceleration filter element 126.

In an optional embodiment, the mineralization pipeline 121, the inhibition pipeline 122, and the acceleration pipeline 123 are arranged in parallel and can simultaneously output water. Specifically, the mineralization pipeline 121, the inhibition pipeline 122, and the acceleration pipeline 123 are connected in parallel between the water inlet pipeline 109 of the mineralization filter element unit 50 and the water outlet pipeline 60 of the mineralization filter element unit 50. The water inlet pipeline 109 can be connected to the mineralization pipeline 121, the inhibition pipeline 122, and the acceleration pipeline 123 through a multi-way valve or a flow divider valve, and the mineralization pipeline 121, the inhibition pipeline 122, and the acceleration pipeline 123 can be connected to the water outlet pipeline 60 through a multi-way valve. When the mineralization pipeline 121, the inhibition pipeline 122, and the acceleration pipeline 123 simultaneously output water, the water from the mineralization pipeline 121, the inhibition pipeline 122, and the acceleration pipeline 123 can be mixed and then discharged through the water outlet pipeline 60.

The mineralization filter element 124 is arranged in the mineralization pipeline 121, and the mineralization filter element 124 can release (dissolve) minerals into the water flowing therethrough, thereby making the water output from the mineralization pipeline 121 contain minerals, to meet a requirement of people for mineralized drinking water. The inhibition filter element 125 is arranged in the inhibition pipeline 122, and the inhibition filter element 125 can release an inhibitory substance into the water flowing therethrough. When the water containing the inhibitory substance flows through the mineralization filter element 124, the inhibitory substance can inhibit the dissolution of the minerals in the mineralization filter element 124, thereby avoiding a situation that the mineral content of the water is high. The acceleration filter element 126 is arranged in the acceleration pipeline 123, and the acceleration filter element 126 can release an accelerant into the water flowing therethrough. When the water containing the accelerant flows through the mineralization filter element 124, the accelerant can accelerate the dissolution of the minerals in the mineralization filter element 124, thereby increasing the mineral content of the water.

In an optional embodiment, the mineralization filter element unit 50 further includes a first connection pipeline 127. The first connection pipeline 127 is arranged between the mineralization pipeline 121 and the inhibition pipeline 122 and is configured to connect the inhibition filter element 125 to the mineralization filter element 124 in series. An output end of the first connection pipeline 127 is connected to the mineralization pipeline 121 or the mineralization filter element 124, and an input end of the first connection pipeline 127 is connected to the inhibition pipeline 122 or the inhibition filter element 125. In this way, a mineralization structure in which the inhibition filter element 125 is located upstream and the mineralization filter element 124 is located downstream can be formed, and the water containing the inhibitory substance flows through a waterway of the mineralization filter element 124.

In an optional embodiment, the mineralization filter element unit 50 further includes a second connection pipeline 128. The second connection pipeline 128 is arranged between the mineralization pipeline 121 and the acceleration pipeline 123 and is configured to connect the acceleration filter element 126 to the mineralization filter element 124 in series. An output end of the first connection pipeline 127 is connected to the mineralization pipeline 121 or the mineralization filter element 124, and an input end of the first connection pipeline 127 is connected to the acceleration pipeline 123 or the acceleration filter element 126. In this way, a mineralization structure in which the promotion filter element 126 is located upstream and the mineralization filter element 124 is located downstream can be formed, and the water containing the accelerant flows through the waterway of the mineralization filter element 124.

In an optional embodiment, a first control valve 1291 is arranged at the first connection pipeline 127. The first control valve 1291 has a state of allowing water to flow through and a state of not allowing water to flow through. In specific applications, the first control valve 1291 can also be a flow valve.

In an optional embodiment, a second control valve 1292 is arranged at the second connection pipeline 128. The second control valve 1292 has a state of allowing water to flow through and a state of not allowing water to flow through. In specific applications, the second control valve 1292 can also be a flow valve.

In an optional embodiment, the mineralization pipeline 121 is provided with a third control valve 1293 for controlling blocking and unblocking and/or a flow rate of the mineralization pipeline 121. The third control valve 1293 is arranged at an upstream end of the mineralization filter element 124.

In an optional embodiment, the inhibition pipeline 122 is provided with a fourth control valve 1294 for controlling blocking and unblocking and/or a flow rate of the inhibition pipeline 122. Since the fourth control valve 1294 is arranged at the downstream end of the inhibition filter element 125, it can be achieved whether to convey water to the inhibition filter element 125 by controlling opening or closing of the fourth control valve 1294.

In an optional embodiment, the acceleration pipeline 123 is provided with a fifth control valve 1295 for controlling blocking and unblocking and/or a flow rate of the acceleration pipeline 123. Since the fifth control valve 1295 is arranged at the downstream end of the acceleration filter element 126, it can be achieved whether to convey water to the acceleration filter element 126 by controlling opening or closing of the fifth control valve 1295.

One end of the first connection pipeline 127 is connected between the third control valve 1293 and the mineralization filter element 124, and the other end of the first connection pipeline 127 is connected between the inhibition filter element 125 and the fourth control valve 1294. Since the third control valve 1293 is arranged at the upstream end of the mineralization filter element 124 and the fourth control valve 1294 is arranged at the downstream end of the inhibition filter element 125, the input end of the first connection pipeline 127 is connected to the downstream end of the inhibition filter element 125, and the output end of the first connection pipeline 127 is connected to the upstream end of the mineralization filter element 124. When the third control valve 1293 and the fourth control valve 1294 are controlled to be closed, and the first control valve 1291 is in the state of allowing water to flow through, the water containing the inhibitory substance can flow to the first connection pipeline 127 and then to the mineralization filter element 124.

One end of the second connection pipeline 128 is connected between the third control valve 1293 and the mineralization filter element 124, and the other end of the second connection pipeline 128 is connected between the acceleration filter element 126 and the fifth control valve 1295. Since the third control valve 1293 is arranged at the upstream end of the mineralization filter element 124 and the fifth control valve 1295 is arranged at the downstream end of the acceleration filter element 126, the input end of the second connection pipeline 128 is connected to the downstream end of the acceleration filter element 126, and the output end of the second connection pipeline 128 is connected to the upstream end of the mineralization filter element 124. When the third control valve 1293 and the fifth control valve 1295 are controlled to be closed, and the second control valve 1292 is in the state of allowing water to flow through, the water containing the accelerant can flow to the second connection pipeline 128 and then to the mineralization filter element 124.

By controlling the opening or closing of the first control valve 1291, the second control valve 1292, the third control valve 1293, the fourth control valve 1294, and the fifth control valve 1295, at least two of the mineralization pipeline 121, the inhibition pipeline 122, and the acceleration pipeline 123 can be simultaneously or separately output water, and the water flowing through the inhibition filter element 125 can enter the mineralization filter element 124 through the first connection pipeline 127, or the water flowing through the acceleration filter 126 can enter the mineralization filter element 124 through the second connection pipeline 128, to make pipeline structures meet different requirements.

For example, when the mineralization pipeline 121, the inhibition pipeline 122, and the acceleration pipeline 123 need to output water simultaneously, the third control valve 1293, the fourth control valve 1294, and the fifth control valve 1295 can be controlled to be opened, and the first control valve 1291 and the second control valve 1292 can be controlled to be in the state of not allowing water to pass through. In this case, the first connection pipeline 127 and the second connection pipeline 128 are both blocked, and the mineralization pipeline 121, the inhibition pipeline 122, and the acceleration pipeline 123 are connected in parallel between the water inlet pipeline 109 and the water outlet pipeline 60 and are arranged in parallel. The water in the mineralization pipeline 121, the water in the inhibition pipeline 122, and the water in the acceleration pipeline 123 are discharged after being mixed in the water outlet pipeline 60.

For example, when the mineralization filter element 124 is in the soaked state, the first control valve 1291 can be controlled to be in the state of allowing water to flow through; the second control valve 1292 can be controlled to be in the state of not allowing water to flow through; and the third control valve 1293, the fourth control valve 1294, and the fifth control valve 1295 can be controlled to be closed. In this way, both the second connection pipeline 128 and the acceleration pipeline 123 are blocked. The inhibition filter element 125 and the mineralization filter element 124 are connected through the first connection pipeline 127. The water containing the inhibitory substance can flow through the first connection pipeline 127 to the mineralization filter element 124, thus allowing the water containing the inhibitory substance to enter and fill the mineralization filter element 124. The mineralization filter element 124 can be soaked in the water containing the inhibitory substance.

For example, in order to prevent an excessive mineral content caused by soaking of the mineralization filter element 124, the first control valve 1291 can be controlled to be in the state of allowing water to flow through; the second control valve 1292 can be controlled to be in the state of not allowing water to flow through; the third control valve 1293 and the fourth control valve 1294 can be controlled to be closed; and the fifth control valve 1295 can be controlled to be opened. In this case, the second connection pipeline 128 is blocked. The inhibition filter element 125 and the mineralization filter element 124 are connected through the first connection pipeline 127. The water containing the inhibitory substance can flow to the mineralization filter element 124 through the first connection pipeline 127, thereby inhibiting the release of minerals from the mineralization filter element 124 and preventing the mineral content of the water from exceeding a standard content. The acceleration pipeline 123 is unblocked, so that the water containing the accelerant can flow to the water outlet pipeline 60. The acceleration filter element 126 can include a filter material that releases minerals, thereby adding the new kind of mineral into the water. For example, the acceleration filter element 126 includes a periclase filter material described below. The periclase filter material is an alkaline filter material, and released (dissolved) periclase can adjust the pH value of water, to improve the taste of drinking water and maintain a healthy state of a human body.

For example, when the mineralization filter element 124 is the middle to late stage of its service life, the first control valve 1291 can be controlled to be in the state of not allowing water to flow through; the second control valve 1292 can be controlled to be in the state of allowing water to flow through; and the third control valve 1293, the fourth control valve 1294, and the fifth control valve 1295 can be controlled to be closed. In this case, both the first connection pipeline 127 and the inhibition pipeline 122 are blocked, and the acceleration filter element 126 and the mineralization filter element 124 are connected through the second connection pipeline 128. The water containing the accelerant can flow to the mineralization filter element 124 through the second connection pipeline 128, thereby accelerating the release of minerals from the mineralization filter element 124 and ensuring that the minerals in the water can meet a standard. Even if the mineralization filter element 124 is in the middle to late stage of its lifespan (the dissolution rate of minerals decreases), by using the acceleration filter element 126, the dissolution rate of the minerals in the mineralization filter element 124 is maintained within a set range, and the service life of the mineralization filter element 124 can be prolonged. Or, in an expected large flow rate, the first control valve 1291 can be controlled to be in the state of not allowing water to flow through; the second control valve 1292 can be controlled to be in the state of allowing water to flow through; and the third control valve 1293, the fourth control valve 1294, and the fifth control valve 1295 can be controlled to be closed, so that the minerals in the water can meet the standard at the large flow rate.

For example, in an expected large flow rate, when a new kind of mineral is added into the water, the first control valve 1291 can be controlled to be in the state of not allowing water to flow through; the second control valve 1292 can be controlled to be in the state of allowing water to flow through; the third control valve 1293 and the fifth control valve 1295 can be controlled to be closed; and the fourth control valve 1294 can be controlled to be opened. In this case, the first connection pipeline 127 is blocked. The promotion filter element 126 and the mineralization filter element 124 are connected through the second connection pipeline 128. The water containing the accelerant can flow to the mineralization filter element 124 through the second connection pipeline 128, thereby promoting the release of minerals from the mineralization filter element 124, to make the minerals in the water to meet the standard. The inhibition pipeline 122 is unblocked, so that the water containing the inhibitory substance can flow to the water outlet pipeline 60. The inhibition filter element 125 can include a filter material that releases minerals, thereby adding the new kind of mineral into the water. For example, the inhibition filter element 125 includes a zeolite filter material described below. Zeolite released (dissolved) by the zeolite filter material can adsorb harmful substances such as heavy metals, ammonium, and hydrogen compounds in water, which greatly improves the water quality. In addition, zeolite can further adjust the pH value of water, to improve the taste of drinking water and maintain a healthy state of a human body.

In an optional embodiment, the first control valve 1291, the second control valve 1292, the third control valve 1293, the fourth control valve 1294, and the fifth control valve 1295 are all electromagnetic valves. Of course, in other embodiments, the first control valve 1291, the second control valve 1292, the third control valve 1293, the fourth control valve 1294, and the fifth control valve 1295 can further use other valves.

In an optionally embodiment, the mineralization filter element 124 includes a metasilicic-acid-containing filter material; the inhibition filter element 125 includes a zeolite filter material; and the acceleration filter element 126 includes an alkaline filter material. In other embodiments, the mineralization filter element 124 can further include a filter material containing other minerals, such as copper, calcium, magnesium, potassium, strontium, and zinc. It should be noted that when the mineralization filter element 124 includes the filter material containing other minerals, a corresponding acceleration filter material is matched in the acceleration filter element 126, and a corresponding inhibition filter material is matched in the inhibition filter element 125.

In an optional embodiment, the mineralization filter element 124 includes maifanite; the acceleration filter element 126 includes periclase; and the inhibition filter element 125 includes zeolite.

By using the above filter element unit 50, the water containing the inhibitory substance is conveyed to the mineralization filter element 124, to inhibit the release of minerals from the mineralization filter element 124, thereby preventing an excessive mineral content of the water. Furthermore, the water containing the accelerant is conveyed to the mineralization filter element 124 to accelerate the release of minerals from the mineralization filter element 124, to prevent the phenomenon that the mineral content of the water does not meet the standard.

As shown in FIG. 13, the mineralization waterway system 1 further includes a first water quality testing instrument 130 and a second water quality testing instrument 132.

The first water quality testing instrument 130 can be arranged at a water inlet of the mineralization filter element unit 50. In an optional embodiment, the first water quality testing instrument is arranged at the water inlet pipeline 109 of the mineralization filter element unit 50, to test a first water quality parameter of the upstream of the mineralization filter element unit 50. The second water quality testing instrument 132 can be arranged at a water outlet of the mineralization filter element unit 50. In an optional embodiment, the second water quality testing instrument 132 is arranged at the water outlet pipeline 60 of the mineralization filter element unit 50, to test a second water quality parameter of the downstream of the mineralization filter element unit.

A water quality testing instrument (the first water quality testing instrument 130 and the second water quality testing instrument 132) can be a Total Dissolved Solids (TDS) tester or can be a conductivity meter. When the first water quality testing instrument 130 and the second water quality testing instrument 132 are the TDS testers, correspondingly, the first water quality parameter is a first TDS value, and the second water quality parameter is a second TDS value. When the first water quality testing instrument 130 and the second water quality testing instrument 132 are the conductivity meters, correspondingly, the first water quality parameter is a first conductivity value, and the second water quality parameter is a second conductivity value.

A total dissolved solids (TDS) value is a total amount of solids dissolved in water, including a content of inorganic substances and a content of organic substances. A measurement unit is milligrams per liter (1 mg/L=1 ppm), indicating how many milligrams of dissolved total solids are dissolved in a liter of water. A larger TDS value indicates more dissolved matters contained in the water. Generally, a conductivity value can be used to roughly understand a salt content of the solution. A higher conductivity indicates a higher salt content and a larger TDS value. The higher conductivity indicates that an ion concentration of the water is high, which can contain more dissolved matters.

In an embodiment, the first water quality testing instrument 130 and the second water quality testing instrument 132 are respectively electrically connected to the control module. The first water quality testing instrument 130 transmits the detected first water quality parameter to the control module, and the second water quality testing instrument 132 transmits the detected second water quality parameter to the control module. After obtaining the first water quality parameter and the second water quality parameter, the control module can calculate a pH value of the water according to the second water quality parameter and the first water quality parameter.

In an embodiment, the control module calculates and obtains a water quality parameter difference according to the second water quality parameter and the first water quality parameter, and can obtain the pH value of the water obtained by the mineralization filter element unit 50 according to a corresponding relationship between a preset water quality parameter difference and the pH value of the water. The corresponding relationship is a mathematical function obtained by fitting a relationship between the water quality parameter difference and the pH value using a data fitting method (such as linear regression, polynomial regression, and a machine learning algorithm).

Referring to FIG. 2 together, the mineralization waterway system 1 further includes a variable frequency water pump 70. The variable frequency water pump 70 is arranged at the water inlet pipeline 10.

Different gears correspond to different pump rates or pump rate ranges. For example, when the mineralization waterway system 1 is in a first gear, the variable frequency water pump 70 has a first pump rate/pump rate range. When the mineralization waterway system 1 is in a second gear, the variable frequency water pump 70 has a second pump rate/pump rate range. When the mineralization waterway system 1 is in a third gear, the variable frequency water pump 70 has a third pump rate/pump rate range. When the mineralization waterway system 1 is in a fourth gear, the variable frequency water pump 70 has a fourth pump rate/pump rate range.

In an embodiment, the control module dynamically adjusts a pump rate of the variable frequency water pump 70 according to different gears of the mineralization waterway system 1 and different parameter differences between the first water quality parameter and the second water quality parameter, to control the pH of the water obtained according to the parameter difference within a preset pH range.

If the pH value of the water is less than a lower limit of the preset pH range, the control module increases the pump rate of the variable frequency water pump 70 to increase the flow rate of the water, which can enhance the mineralization effect of the mineralization filter element unit 50 or accelerate water quality balance. If the pH value of the water exceeds an upper limit of the preset pH range, the control module decreases the pump rate of the variable frequency water pump by 70, to reduce the flow rate of the water and avoid excessive mineralization or water quality imbalance. The adjusted pump rate should be maintained within a preset pump rate range of a current gear, to ensure system stability and meet user needs.

In practical applications, when a user selects a gear, a corresponding pump rate/pump rate range of the variable frequency water pump 70 is set, namely, a basic flow rate and a mineralization effect have already been set. Afterwards, controlling the variable frequency water pump 70 according to the pH value of the water is to perform dynamic adjustment and optimization on this.

The following enumerates some application scenarios to describe the control of the variable frequency water pump.

Assuming that a user selects the first gear, the control module sets the basic pump rate of the variable frequency water pump to the first pump rate, and the water inlet pipeline supplies the water at the first flow rate. The pH value of the water, calculated according to the first water quality testing instrument and the second water quality testing instrument, is 7.2 (a target pH range is 7.0 to 7.5). Since the pH value of the water is within the target pH range, the control module maintains the pump rate of the variable frequency water pump unchanged.

Assuming that a user selects the second gear, the control module sets the basic pump rate of the variable frequency water pump to the second pump rate, and the water inlet pipeline supplies the water at the second flow rate. The pH value of the water, calculated according to the first water quality testing instrument and the second water quality testing instrument, is 6.9 (a target pH range is 7.0 to 7.5). Since the pH value of the water is not within the target pH range, the control module increases the pump rate of the variable frequency water pump (but still maintains it within the preset pump rate range of the second gear), to increase the flow rate of water and enhances the mineralization effect, with the aim of increasing the pH value to the target range.

Assuming that a user selects the third gear, the control module sets the basic pump rate of the variable frequency water pump to the third pump rate, and the water inlet pipeline supplies the water at the third flow rate. The pH value of the water, calculated according to the first water quality testing instrument and the second water quality testing instrument, is 7.8 (a target pH range is 7.0 to 7.5). Since the pH value of the water is not within the target pH range, the control module decreases the pump rate of the variable frequency water pump (but still maintains it within the preset pump rate range of the third gear), to decrease the flow rate of water and avoid a large pH value caused by excessive mineralization.

By controlling the pump rate of the variable frequency water pump according to the pH value of the water, different flow rates can be achieved at different gears, and dynamic adjustment can maintain the stability of the pH value of the water, thereby meeting needs of users for different water qualities and ensuring safe and efficient operations of the system Dynamically adjusting the pump rate of the variable frequency water pump according to the pH value of the water avoids unnecessary energy consumption. When the water approaches the target range, the pump rate is decreased to reduce the energy consumption.

In other embodiments, the control module can further control opening and closing of control valves in the mineralization filter element unit 50 according to the pH value of the water, thereby further maintaining the pH value of the water obtained by the mineralization filter element unit 50 within a preset water pH threshold range.

Referring to FIG. 14, a schematic structural diagram of a mineralization water purifier 2 according to an embodiment of the present disclosure is shown. The mineralization water purifier 2 includes a mineralization waterway system 1. For the mineralization waterway system 1, refer to FIG. 1 to FIG. 13 and its relevant descriptions.

It should be understood that the various variations and specific embodiments of the mineralization waterway system 1 provided in the above embodiments are also applicable to the mineralization water purifier 2 in this embodiment. Through the detailed description of the mineralization waterway system 1, those skilled in the art can clearly understand an implementation process of the mineralization water purifier 2 in this embodiment. For the sake of simplicity of the specification, it will not be described in detail here.

It can be understood that the mineralization waterway system according to the embodiments of the present disclosure includes hardware structures and/or software modules corresponding to the execution of various functions. The embodiments of the present disclosure can be implemented in the form of hardware or a combination of hardware and computer software in combination with units and algorithm steps of the various examples described in the embodiments of the present disclosure. Whether a function is implemented in hardware or in a manner of driving hardware by computer software depends on particular applications and design constraint conditions of the technical solutions. A person skilled in the art can use different methods to implement the described functions for each particular application, but it should not be considered that this implementation goes beyond the scope of the technical solutions of the embodiments of the present disclosure.

It can be understood that “plurality” in the embodiments of the present disclosure mean two or more, and other quantifiers are similar to it. The term “and/or” describes an association relationship of associated objects, representing those three relationships can exist. For example, A and/or B can represent three situations: A exists alone; A and B exist simultaneously; and B exists alone. The character “/” usually indicates an “or” relation between associated objects. The singular forms of “one” and “the” are also intended to include a plural form, unless the context clearly indicates other meanings.

It can be further understood that the terms “first”, “second”, and the like are used for describing various information, but the information should be not limited by these terms. These terms are only used to distinguish information of the same type from each other, and do not represent a particular order or importance. Actually, the terms “first”, “second”, and the like can be completely interchanged for use. For example, without departing from the scope of the embodiments of the present disclosure, first information can also be referred to as second information, and similarly, second information can also be referred to as first information.

Further, it can be understood that orientations or positional relationships indicated by the terms “center”, “longitudinal”, “transverse”, “front”, “rear”, “upper”, “lower”, “left”, “right”, “vertical”, “horizontal”, “top”, “bottom”, “inner”, “outer”, and the like are orientations or positional relationships as shown in the drawings, and are only for the purpose of facilitating and simplifying the descriptions of this embodiment instead of indicating or implying that devices or elements indicated must have particular orientations, and be constructed and operated in the particular orientations.

It can be further understood that, unless otherwise specified, “connection” includes direct connections between two entities without any other components between them, as well as indirect connections between two entities with other components between them.

It can be further understood that although the operations are described in a specific order in the accompanying drawings in the embodiments of the present disclosure, they should not be understood as requiring the execution of these operations in the specific order or serial order shown, or requiring the execution of all the operations shown to achieve the desired results. In a specific environment, multitasking and parallel processing can be advantageous.

Those skilled in the art will easily come up with other implementations of the embodiments of the present disclosure after considering this specification and implementing the invention disclosed here. The present disclosure aims to cover any variations, uses, or adaptive changes of the embodiments of the present disclosure, and these variations, uses, or adaptive changes follow the general principles of the embodiments of the present disclosure and include common knowledge or customary technical means in the technical field that are not disclosed in the embodiments of the present disclosure. This specification and the embodiments are considered as merely exemplary, and the real scope and spirit of the embodiments of the present disclosure are pointed out in the following claims.

It should be understood that the embodiments of the present disclosure are not limited to the precise structures that have been described above and shown in the drawings, and various modifications and changes can be made without departing from the scope of the present disclosure. The scope of the embodiments of the present disclosure is subject only to the appended claims.

What is claimed is:

1. A mineralization waterway system, comprising:
a water inlet pipeline;
a water outlet pipeline;
a first filter element unit and a second filter element unit;
a mineralization filter element unit, connected to the water outlet pipeline; and
a first valve body, comprising a first water outlet end and a second water outlet end, wherein the first water outlet end is connected to the first filter element unit, and the second water outlet end is connected to the second filter element unit;
wherein when the mineralization waterway system is in a first gear, water flows from the water inlet pipeline into the first valve body, and then flows out from the first water outlet end to the first filter element unit; purified water obtained by the first filter element unit enters the mineralization filter element unit; wastewater discharged from the first filter element unit enters the second filter element unit; purified water obtained by the second filter element unit enters the mineralization filter element unit; and water mineralized by the mineralization filter element unit is discharged through the water outlet pipeline.

2. The mineralization waterway system according to claim 1, wherein a wastewater pipeline is arranged between a wastewater outlet of the first filter element unit and a water inlet end of the second filter element unit; a check valve is arranged on the wastewater pipeline; and the check valve is configured to allow the wastewater filtered from the first filter element unit to flow into the second filter element unit and prohibit back flowing.

3. The mineralization waterway system according to claim 2, wherein when the mineralization waterway system is in a second gear, water flows from the water inlet pipeline into the first valve body, and then flows out from the first water outlet end to the first filter element unit; purified water obtained by the first filter element unit enters the mineralization filter element unit; and wastewater discharged from the first filter element unit is discharged through a first wastewater discharging channel.

4. The mineralization waterway system according to claim 3, wherein when the mineralization waterway system is a third gear, water flows from the water inlet pipeline into the first valve body, and then flows out from the second water outlet end to the second filter element unit; purified water obtained by the second filter element unit enters the mineralization filter element unit; and wastewater discharged from the second filter element unit is discharged through a second wastewater discharging channel.

5. The mineralization waterway system according to claim 4, wherein when the mineralization waterway system is in a fourth gear, water flows from the water inlet pipeline into the first valve body, then flows out from the first water outlet end to the first filter element unit, and flows out from the second water outlet end to the second filter element unit; purified water obtained by the first filter element unit and purified water obtained by the second filter element unit enter the mineralization filter element unit; wastewater discharged from the first filter element unit is discharged through the first wastewater discharging channel; and wastewater discharged from the second filter element unit is discharged through the second wastewater discharging channel.

6. The mineralization waterway system according to claim 5, wherein the first filter element unit is provided with a plurality of first filter sub-elements; and the plurality of first filter sub-elements are connected in series or in parallel in sequence or are in parallel-series connection in sequence.

7. The mineralization waterway system according to claim 6, wherein the second filter element unit is provided with a plurality of second filter sub-elements; and the plurality of second filter sub-elements are connected in series or in parallel in sequence or are in parallel-series connection in sequence.

8. The mineralization waterway system according to claim 1, wherein the mineralization filter element unit comprises a mineralization pipeline, and a mineralization filter element is arranged on the mineralization pipeline.

9. The mineralization waterway system according to claim 1, wherein the mineralization filter element unit comprises: a mineralization pipeline and an inhibition pipeline which are arranged in parallel and capable of simultaneously or separately discharging water; the mineralization pipeline is provided with a mineralization filter element; the inhibition pipeline is provided with an inhibition filter element; a serially-connected switching pipeline is arranged between the mineralization pipeline and the inhibition pipeline; the serially-connected switching pipeline is configured to connect the inhibition filter element to the mineralization filter element in series; an output side of the serially-connected switching pipeline is connected to the mineralization pipeline or the mineralization filter element; an input side of the serially-connected switching pipeline is connected to the inhibition pipeline or the inhibition filter element; and a control valve is arranged on the serially-connected switching pipeline.

10. The mineralization waterway system according to claim 9, wherein the mineralization filter element comprises a zinc-containing filter material; and the inhibition filter element comprises an alkaline filter material.

11. The mineralization waterway system according to claim 9, wherein the mineralization filter element comprises a first alkaline filter material; the inhibition filter element comprises a second alkaline filter material; and the second alkaline filter material is configured to inhibit dissolution of an alkaline substance from the first alkaline filter material.

12. The mineralization waterway system according to claim 1, wherein the mineralization filter element unit comprises: a mineralization pipeline and an acceleration pipeline which are arranged in parallel and capable of simultaneously or separately discharging water; the mineralization pipeline is provided with a mineralization filter element; the acceleration pipeline is provided with an acceleration filter element; a serially-connected switching pipeline is arranged between the mineralization pipeline and the acceleration pipeline; the serially-connected switching pipeline is configured to connect the acceleration filter element to the mineralization filter element in series; an output side of the serially-connected switching pipeline is connected to the mineralization pipeline or the mineralization filter element; an input side of the serially-connected switching pipeline is connected to the acceleration pipeline or the acceleration filter element; and a control valve is arranged on the serially-connected switching pipeline.

13. The mineralization waterway system according to claim 12, wherein the mineralization filter element comprises a metasilicic-acid-containing filter material, and the acceleration filter element comprises an alkaline filter material.

14. The mineralization waterway system according to claim 13, wherein the mineralization filter element comprises maifanite, and the acceleration filter element comprises periclase.

15. The mineralization waterway system according to claim 1, wherein the mineralization filter element unit comprises: a mineralization pipeline, an inhibition pipeline, and an acceleration pipeline which are arranged in parallel and capable of simultaneously or separately discharging water; the mineralization pipeline is provided with a mineralization filter element; the inhibition pipeline is provided with an inhibition filter element; the acceleration pipeline is provided with an acceleration filter element; a first connection pipeline is arranged between the mineralization pipeline and the inhibition pipeline; an output side of the first connection pipeline is connected to the mineralization pipeline or the mineralization filter element; an input side of the first connection pipeline is connected to the inhibition pipeline or the inhibition filter element; a second connection pipeline is arranged between the mineralization pipeline and the acceleration pipeline; an output side of the second connection pipeline is connected to the mineralization pipeline or the mineralization filter element; an input side of the second connection pipeline is connected to the acceleration pipeline or the acceleration filter element; the first control valve is arranged at the first connection pipeline; and a second control valve is arranged at the second connection pipeline.

16. The mineralization waterway system according to claim 15, wherein the mineralization filter element comprises a metasilicic-acid-containing filter material; the acceleration filter element comprises an alkaline filter material; and the inhibition filter element comprises a zeolite filter material.

17. The mineralization waterway system according to claim 1, further comprising a first water quality testing instrument and a second water quality testing instrument, wherein the first water quality testing instrument is configured to test a first water quality parameter of an upstream of the mineralization filter element unit; the second water quality testing instrument is configured to test a second water quality parameter of a downstream of the mineralization filter element unit; and a difference between the first water quality parameter and the second water quality parameter is configured to determine a pH value of the water flowing out of the mineralization filter element unit.

18. The mineralization waterway system according to claim 17, wherein a variable frequency water pump is arranged at the water inlet pipeline.

19. The mineralization waterway system according to claim 18, wherein a pump rate of the variable frequency water pump is different according to different gears of the mineralization waterway system and different differences between the first water quality parameter and the second water quality parameter, to control the pH of the water obtained according to the parameter difference within a preset pH range.

20. A mineralization water purifier, comprising the mineralization waterway system according to claim 1.
